(19) United States
(12) Patent Application Publication
(10) Pub. No.: US 2026/0296221 A1
(43) Pub. Date: Oct. 1, 2026

(54) VEHICLE STRUCTURE

(71) Applicant: TOYOTA JIDOSHA KABUSHIKI KAISHA, Toyota-shi (JP)

(72) Inventor: Kotaro HORIGUCHI, Nagoya-shi (JP)

(73) Assignee: TOYOTA JIDOSHA KABUSHIKI KAISHA, Toyota-shi (JP)

(21) Appl. No.: 19/451,041

(22) Filed: Jan. 16, 2026

(30) Foreign Application Priority Data
Mar. 26, 2025 (JP) 2025-052324

(51) Int. Cl. B60L 50/64; H01M 50/342

(52) U.S. Cl. CPC B60L 50/64; H01M 50/3425; H01M 2220/20

(57) ABSTRACT

A vehicle structure including a storage battery cell that is installed in a vehicle, a lower case that is disposed on a lower face of the storage battery cell and that is partially spaced apart from the lower face of the storage battery cell to fashion a smoke exhaust channel, a shear panel that is disposed across a gap from the lower case, and that surrounds and encloses the smoke exhaust channel between the lower case and the shear panel, and a fragile portion that is provided in a portion of the lower case at which the smoke exhaust channel is fashioned, and that is configured to fracture under increase in internal pressure in the smoke exhaust channel.

### CROSS-REFERENCE TO RELATED APPLICATION

This application claims priority to Japanese Patent Application No. 2025-052324 filed on Mar.26, 2025. The disclosure of the above-identified application, including the specification, drawings, and claims, is incorporated by reference herein in its entirety.

### BACKGROUND

### 1. Technical Field

The present disclosure relates to a vehicle structure.

### 2. Description of Related Art

Japanese Unexamined Patent Application Publication No. 2023-46945 (JP 2023-46945 A) discloses a structure in which a battery pack installed in a vehicle accommodates a plurality of battery modules, and a battery case that forms an outer shell of the battery pack is made up of an upper case and a lower case.

### SUMMARY

In a structure including a storage battery, such as that disclosed in JP 2023-46945, a smoke exhaust channel is sometimes provided to allow smoke to escape to outside of a vehicle when smoke is emitted from a storage battery cell for some reason. In a configuration in which such a smoke exhaust channel is provided, it is desirable to suppress increase in internal pressure in the smoke exhaust channel.

An object of the present disclosure is to suppress increase in internal pressure in a smoke exhaust channel.

A vehicle structure according to a first aspect includes a storage battery cell that is installed in a vehicle, a lower case that is disposed on a lower face of the storage battery cell and that is partially spaced apart from the lower face of the storage battery cell to fashion a smoke exhaust channel, a shear panel that is disposed across a gap from the lower case, and that surrounds and encloses the smoke exhaust channel between the lower case and the shear panel, and a fragile portion that is provided in a portion of the lower case at which the smoke exhaust channel is fashioned, and that is configured to fracture under increase in internal pressure in the smoke exhaust channel.

According to the vehicle structure of the first aspect, smoke generated in the storage battery cells flows through the smoke exhaust channel defined by the lower case and the lower faces of the storage battery cells. In the vehicle structure of the first aspect, the fragile portion provided in the portion of the lower case in which the smoke exhaust channel is formed is fractured by increase in the internal pressure of the smoke exhaust channel. Accordingly, increase in the internal pressure of the smoke exhaust channel can be suppressed.

After the fragile portion fractures, smoke from the smoke exhaust channel flows between the lower case and the shear panel, but since the shear panel surrounds and encloses the smoke exhaust channels between itself and the lower case, the smoke is less likely to leak out externally.

According to the vehicle structure of a second aspect, in the first aspect, the fragile portion and the shear panel are spaced apart from each other.

According to the vehicle structure of the second aspect, in a state in which the fragile portion is fractured, space through which smoke can flow out of the smoke exhaust channel can be secured between the smoke exhaust channel and the shear panel.

According to the vehicle structure of a third aspect, in the first aspect, a plurality of the smoke exhaust channels is fashioned in the lower case, and the shear panel surrounds the smoke exhaust channels.

According to the vehicle structure of the third aspect, the shear panel can be shared by multiple smoke exhaust channels, and increase in the number of parts can be suppressed.

According to the vehicle structure of a fourth aspect, in the first aspect, a plurality of the storage battery cells is disposed arrayed side by side, the smoke exhaust channel extends spanning the storage battery cells, and the fragile portion extends in a direction in which the smoke exhaust channel extends.

According to the vehicle structure of the fourth aspect, the fragile portion can fracture at any position in the direction in which the smoke exhaust channel extends, thereby suppressing increase in the internal pressure in the smoke exhaust channel.

According to the vehicle structure of the present disclosure, increase in the internal pressure in the smoke exhaust channel can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a longitudinal sectional view illustrating a vehicle structure according to an embodiment;

FIG. 2 is a cross-sectional view illustrating the vehicle structure according to the embodiment; and

FIG. 3 is an enlarged cross-sectional view illustrating part of the vehicle structure according to the embodiment.

### DETAILED DESCRIPTION OF EMBODIMENTS

An example of an embodiment according to the present disclosure will be described below with reference to the drawings.

Note that in the following, the scope necessary for describing the technology of the present disclosure will be described primarily, and parts that are omitted from description will be based on known technology. Also, the same or similar signs denote parts that are the same as or corresponding to each other in the drawings, and repetitive description will be omitted. Further, when a plurality of mutually identical or corresponding members are included in a drawing, just some of them may be denoted with signs, in order to facilitate viewing of the drawing. In the drawings, arrow FR, arrow UP, and arrow LH indicate a vehicle forward direction, a vehicle upward direction, and a vehicle leftward direction of the vehicle, respectively. In the following description, unless otherwise specified, terms of directions front-rear, up-down, and right-left are used to refer to front and rear in a vehicle front-rear direction, up and down in a vehicle up-down direction, and right and left in a vehicle width direction (right-left direction), respectively.

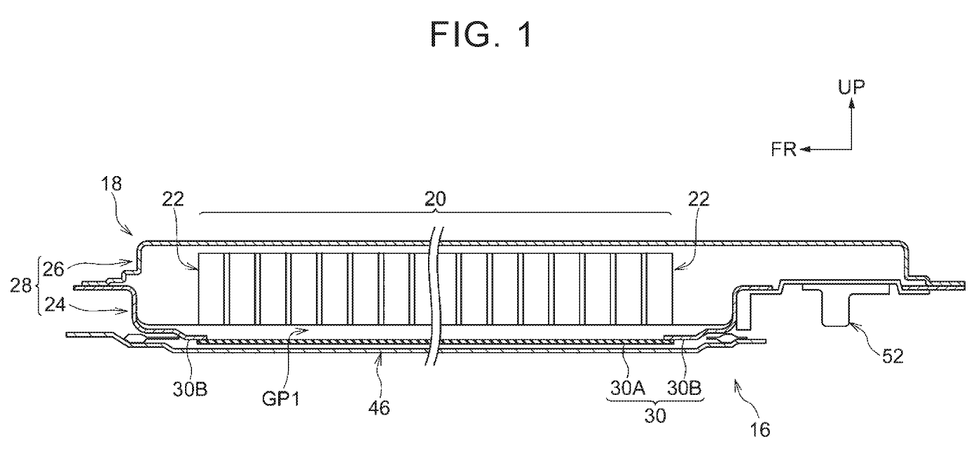

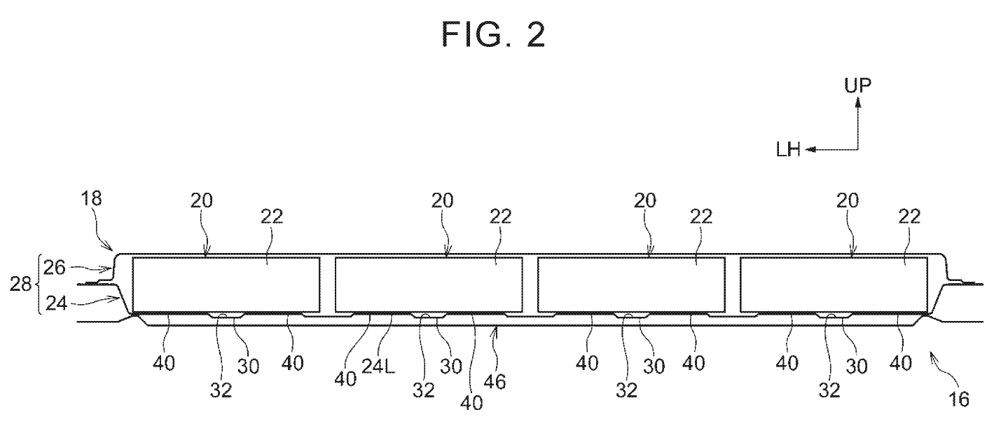

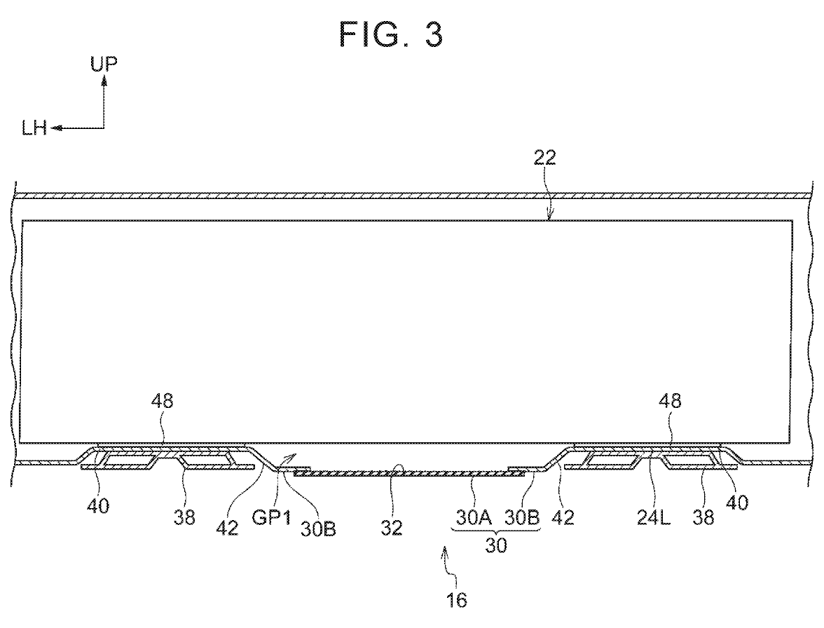

FIG. 1 is a longitudinal sectional view illustrating a vehicle structure 16 according to the present embodiment, in sectional view in the vehicle front-rear direction. FIG. 2 is a cross-sectional view illustrating the vehicle structure 16 according to the present embodiment, in sectional view in the vehicle width direction. FIG. 3 is an enlarged cross-sectional view of a portion of the vehicle structure 16 according to the present embodiment, taken along the vehicle width direction.

As illustrated in FIGS. 1 and 2, a vehicle structure 16 according to the present embodiment includes a storage battery pack 18 installed in the vehicle. As illustrated in FIG. 2, the storage battery pack 18 includes a plurality of (e.g., four) storage battery modules 20. The storage battery modules 20 are disposed arrayed side by side in the vehicle width direction.

Each of the storage battery modules 20 has a plurality of storage battery cells 22. As illustrated in FIG. 1, the storage battery cells 22 are disposed in the storage battery module 20, arrayed side-by-side in the vehicle front-rear direction. That is to say, the storage battery pack 18 is configured such that the storage battery modules 20, having the storage battery cells 22 disposed in the vehicle front-rear direction, are disposed arrayed side-by-side in the vehicle width direction. As described above, the storage battery cells 22 provided in the storage battery pack 18 are installed in the vehicle.

As illustrated in FIGS. 1 and 2, the storage battery pack 18 has a lower case 24 and an upper cover 26. The lower case 24 is a case disposed on a downward side of the storage battery modules 20. This lower case 24 is a box-shaped member that can accommodate the storage battery modules 20. The upper cover 26 is a cover disposed on an upward side of the storage battery modules 20. This upper cover 26 is a lid-like member that closes the upper face of the lower case 24.

A periphery of the lower case 24 and a periphery of the upper cover 26 are joined together. Specifically, the lower case 24 and the upper cover 26 are joined to each other at their respective front end portions, at their respective rear end portions, at their respective right end portions, and at their respective left end portions. Thus, the lower case 24 and the upper cover 26 make up a storage battery case 28. The storage battery modules 20, each made up of multiple storage battery cells 22, are accommodated in internal space of this storage battery case 28 and are arrayed side-by-side in the vehicle width direction.

As illustrated in FIGS. 2 and 3, a lower plate 24L of the lower case 24 has contact portions 40 and channel portions 30. In the present embodiment, as illustrated in FIG. 2, a plurality of (for example, four) the channel portions 30 is provided to the lower case 24. A plurality of (e.g., eight) the contact portions 40 is provided on the lower case 24. The contact portions 40 are portions that come into contact with lower faces of the storage battery cells 22 on both sides in the vehicle width direction. As illustrated in FIG. 3, the lower case 24 is attached to the lower faces of the storage battery cells 22, at the contact portions 40, by adhesive 48 or the like, for example.

As illustrated in FIG. 3, the channel portions 30 are formed at the middle of the storage battery cells 22 in the vehicle width direction, spaced apart from the lower faces of the storage battery cells 22. Gaps GP1 are formed between the lower faces of the storage battery cells 22 and the channel portions 30. The gaps GP1 make up a part of smoke exhaust channels 32. In this way, the lower case 24 is disposed on the lower faces of the storage battery cells 22, and is partially spaced apart from the lower faces of the storage battery cells 22 to form the smoke exhaust channels 32. As illustrated in FIG. 2, one of the smoke exhaust channels 32 is provided for each of the storage battery cells 22. Accordingly, in the present embodiment, multiple (e.g., four) of the smoke exhaust channels 32 are formed in the lower case 24.

In a case in which gas containing smoke (hereinafter, this gas will be referred to simply as "smoke") is generated in one of the storage battery cells 22 for some reason, the smoke is discharged from the middle position in the vehicle width direction on the lower face of the storage battery cell 22. Accordingly, smoke generated in the storage battery cells 22 flows into the smoke exhaust channels 32 formed by the channel portions 30. The configuration thereof is such that smoke that flows through the smoke exhaust channels 32 is externally discharged through a smoke discharge valve 52. The smoke discharge valve 52 opens when the internal pressure of the smoke exhaust channel 32 becomes higher than external pressure, for example. In this way, the vehicle structure 16 has a function of discharging smoke, and can therefore also be referred to as a smoke exhaust structure.

In the lower case 24, the contact portions 40 and the channel portions 30 are different portions. The channel portions 30 are disposed at positions offset in the vehicle width direction relative to the contact portions 40. Between the channel portions 30 and the contact portions 40, inclined portions 42 that are inclined with respect to each of the channel portions 30 and the contact portions 40 are provided. The inclined portions 42 extend obliquely upward and outward in the vehicle width direction from each of a right end portion and a left end portion of the channel portions 30.

Each of the channel portions 30, and a pair of the inclined portions 42, on the lower case 24, are formed in a convex shape facing downward as viewed from the contact portions 40. The gaps GP1 that make up part of the smoke exhaust channels 32 are each a closed space surrounded by the lower face of the storage battery cell 22, the channel portion 30, and the inclined portion 42. This space has a substantially trapezoidal shape as viewed in cross-section in the vehicle width direction (see FIG. 3). A lower base of this trapezoidal shape is parallel to the lower face of the storage battery cell 22. This trapezoidal shape is a flat trapezoidal shape in which an upper base of the channel portion 30 is longer than the lower base thereof.

Also, the channel portion 30 is formed in each of the storage battery modules 20 so as to extend in the vehicle front-rear direction, i.e., in a direction in which the storage battery cells 22 are arrayed. The length of the channel portion 30 in the vehicle front-rear direction is approximately the same as the length of the storage battery module 20 in the vehicle front-rear direction. The channel portion 30 extends continuously in the vehicle front-rear direction over a range in which the storage battery cells 22 are arrayed. Thus, the gaps GP1 that make up part of the smoke exhaust channels 32 extend in the vehicle front-rear direction, spanning the storage battery cells 22, as illustrated in FIG. 1.

The channel portions 30 each have a fragile portion 30A and a pair of flange portions 30B. That is to say, the fragile portion 30A is provided in a portion of the lower case 24 at which the smoke exhaust channel 32 is formed. The fragile portion 30A forms the middle portion of the channel portion 30 in the vehicle width direction as viewed in a cross-section in the vehicle width direction (see FIG. 3). The flange portions 30B form outer portions (specifically, right end portion and left end portion) of the channel portion 30 in the vehicle width direction as viewed in cross-section in the vehicle width direction (see FIG. 3). Also, the fragile portion 30A forms the middle portion of the channel portion 30 in the vehicle front-rear direction as viewed in a cross-section in the vehicle front-rear direction (see FIG. 1). The flange portions 30B form outer portions (specifically, right end portion and left end portion) of the channel portion 30 in the vehicle front-rear direction as viewed in cross-section in the vehicle front-rear direction (see FIG. 1). Note that in FIG. 2, the channel portion 30 is illustrated in a simplified form.

The flange portions 30B extend from lower end portions of the inclined portions 42 toward the middle in the vehicle width direction (i.e., toward the fragile portion 30A) as viewed in cross-section in the vehicle width direction (see FIG. 3). The fragile portion 30A is attached to the lower faces of the flange portions 30B, between the flange portions 30B, for example. The fragile portion 30A and the flange portions 30B extend in the direction in which the smoke exhaust channel 32 extends (i.e., the front-rear direction).

The fragile portion 30A fractures under increase in the internal pressure of the smoke exhaust channel 32. For example, at least a portion of the fragile portion 30A is configured thinner than the flange portions 30B and the inclined portions 42. When the internal pressure of the smoke exhaust channel 32 rises, the fragile portion 30A fractures before the flange portions 30B and the inclined portions 42 fracture. The internal pressure here is higher than the pressure at which the smoke discharge valve 52 opens. That is to say, the structure is such that the fragile portion 30A fractures when the internal pressure of the smoke exhaust channel 32 rises to an abnormal value after the smoke discharge valve 52 is opened.

Note that when the internal pressure of the smoke exhaust channel 32 rises, the fragile portion 30A may be separated from the flange portions 30B by boundary portions between itself and the flange portions 30B fracturing. In this case, for example, the fragile portion 30A may have the same thickness as the flange portion 30B and the inclined portion 42, or may have a different thickness. Also, the fragile portion 30A may have a constant thickness throughout, or may have a portion that is thinner. Thus, various structures that fracture when the internal pressure of the smoke exhaust channel 32 rises can be employed as the fragile portion 30A.

As illustrated in FIG. 3, coolers 38 are provided at the contact portions 40 of the lower case 24. The coolers 38 are in contact with lower faces of the contact portions 40 at positions different from the smoke exhaust channels 32, and receive heat from the storage battery cells 22 through the lower case 24. Specifically, the coolers 38 are disposed at the contact portions 40 of the lower case 24, on the sides of the smoke exhaust channel 32 (i.e., the channel portion 30) in the vehicle width direction. In the example illustrated in FIG. 3, two coolers 38 are disposed on each side of the channel portion 30.

Each of the coolers 38 has a coolant channel that extends in the vehicle front-rear direction. Heat from the storage battery cells 22 can be transferred to coolant flowing through the coolant channel, thereby cooling the storage battery cells 22. The coolant may be a liquid or a gas. Note that the cooler 38 is an example of a heat-receiving member.

As illustrated in FIGS. 1 and 2, a shear panel 46 is provided on a lower side of the storage battery pack 18. The shear panel 46 and the lower case 24 are disposed with a gap therebetween. Accordingly, the shear panel 46 and the fragile portion 30A are spaced apart. That is to say, there is a space between the shear panel 46 and the lower case 24 including the fragile portion 30A. As illustrated in FIGS. 1 and 2, the shear panel 46 surrounds and encloses the smoke exhaust channel 32 between itself and the lower case 24. Specifically, the shear panel 46 surrounds multiple (e.g., four) smoke exhaust channels 32, as illustrated in FIG. 2. In the present embodiment, the shear panel 46 covers a lower face of the storage battery pack 18 and protects the storage battery module 20 from input from the road surface (e.g., flying stones).

### Operations of Present Embodiment

Next, operations of the present embodiment will be described.

Under normal conditions, the storage battery cells 22 do not generate smoke, but when smoke is generated for some reason, the smoke is discharged from the lower faces of the storage battery cells 22, at positions at the middle in the vehicle width direction. This smoke then flows out into the smoke exhaust channels 32 formed by the gaps GP1 between the channel portions 30 of the lower case 24 and the lower faces of the storage battery cells 22. Further, this smoke is discharged from the smoke discharge valve 52.

Now, in the present embodiment, the fragile portions 30A, provided in the portions, of the lower case 24 where the smoke exhaust channels 32 are formed fracture under the increase in internal pressure of the smoke exhaust channels 32. Accordingly, increase in the internal pressure of the smoke exhaust channels 32 can be suppressed.

After the fragile portions 30A fracture, smoke from the smoke exhaust channels 32 flows between the lower case 24 and the shear panel 46, but since the shear panel 46 surrounds and encloses the smoke exhaust channels 32 between itself and the lower case 24, the smoke is less likely to leak out externally.

In the present embodiment, the fragile portions 30A and the shear panel 46 are spaced apart from each other. Accordingly, in a state in which the fragile portions 30A are fractured, space through which smoke flows out from the smoke exhaust channels 32 can be secured between the smoke exhaust channels 32 and the shear panel 46.

Also, in the present embodiment, the smoke exhaust channels 32 are formed in the lower case 24, and the shear panel 46 surrounds the multiple smoke exhaust channels 32. Accordingly, the shear panel 46 can be shared by multiple smoke exhaust channels 32, thereby suppressing increase in the number of parts.

Also, in the present embodiment, the fragile portions 30A extend in the direction in which the smoke exhaust channels 32 extend. Accordingly, the fragile portions 30A can fracture at any position in the extension direction of the smoke exhaust channels 32, thereby suppressing increase in the internal pressure of the smoke exhaust channels 32.

### Modifications

In the present embodiment, the storage battery cells 22 are disposed arrayed side by side in the vehicle front-rear direction as illustrated in FIG. 1, but this is not restrictive. The storage battery cells 22 may be disposed arrayed side by side in the vehicle width direction. In this case, the gaps GP1 that forms part of the smoke exhaust channels 32 may extend spanning multiple storage battery cells 22 in the vehicle width direction. In this case, the fragile portions 30A may extend along the vehicle width direction, which is the direction of the smoke exhaust channels 32 extend.

In the present embodiment, multiple smoke exhaust channels 32 are formed in the lower case 24, but this is not restrictive. A single smoke exhaust channel 32 may be formed in the lower case 24. In this case, the shear panel 46 surrounds a single smoke exhaust channel 32. Note that when multiple smoke exhaust channels 32 are formed in the lower case 24, the shear panel 46 may be configured to surround a single smoke exhaust channel 32.

The present disclosure is not limited to the above-described embodiment, and various modifications, changes, and improvements can be made without departing from the spirit and scope thereof. For example, configurations may be made in which a plurality of the above-described modifications is combined as appropriate.

The following are appendices regarding the present disclosure.

### Appendix 1

A vehicle structure including

a storage battery cell that is installed in a vehicle,

a lower case that is disposed on a lower face of the storage battery cell and that is partially spaced apart from the lower face of the storage battery cell to fashion a smoke exhaust channel,

a shear panel that is disposed across a gap from the lower case, and that surrounds and encloses the smoke exhaust channel between the lower case and the shear panel, and

a fragile portion that is provided in a portion of the lower case at which the smoke exhaust channel is fashioned, and that is configured to fracture under increase in internal pressure in the smoke exhaust channel.

### Appendix 2

The vehicle structure according to Appendix 1, in which the fragile portion and the shear panel are spaced apart from each other.

### Appendix 3

The vehicle structure according to claim 1 or 2, in which

a plurality of the smoke exhaust channels is fashioned in the lower case, and

the shear panel surrounds the smoke exhaust channels.

### Appendix 4

The vehicle structure according to any one of appendices 1 to 3, in which

a plurality of the storage battery cells is disposed arrayed side by side,

the smoke exhaust channel extends spanning the storage battery cells, and

the fragile portion extends in a direction in which the smoke exhaust channel extends.

What is claimed is:

1. A vehicle structure comprising:
a storage battery cell that is installed in a vehicle;
a lower case that is disposed on a lower face of the storage battery cell and that is partially spaced apart from the lower face of the storage battery cell to fashion a smoke exhaust channel;
a shear panel that is disposed across a gap from the lower case, and that surrounds and encloses the smoke exhaust channel between the lower case and the shear panel; and
a fragile portion that is provided in a portion of the lower case at which the smoke exhaust channel is fashioned, and that is configured to fracture under increase in internal pressure in the smoke exhaust channel.

2. The vehicle structure according to claim 1, wherein the fragile portion and the shear panel are spaced apart from each other.

3. The vehicle structure according to claim 1, wherein
a plurality of the smoke exhaust channels is fashioned in the lower case, and
the shear panel surrounds the smoke exhaust channels.

4. The vehicle structure according to claim 1, wherein
a plurality of the storage battery cells is disposed arrayed side by side,
the smoke exhaust channel extends spanning the storage battery cells, and
the fragile portion extends in a direction in which the smoke exhaust channel extends.
